(19) United States
(12) Patent Application Publication
(10) Pub. No.: US 2017/0282364 A1
(43) Pub. Date: Oct. 5, 2017

(54) METHOD OF CONTROLLING A ROBOTIZED ARM SEGMENT MAKING IT POSSIBLE TO ADAPT THE APPARENT STIFFNESS THEREOF

(71) Applicant: COMMISSARIAT A L'ENERGIE ATOMIQUE ET AUX ENERGIES ALTERNATIVES, Paris (FR)

(72) Inventor: Neil ABROUG, Grenoble (FR)

(73) Assignee: COMMISSARIAT A L'ENERGIE ATOMIQUE ET AUX ENERGIES ALTERNATIVES, Paris (FR)

(21) Appl. No.: 15/512,159

(22) PCT Filed: Sep. 29, 2015
(86) PCT No.: PCT/EP2015/072477

§ 371 Date: Mar. 17, 2017

(30) Foreign Application Priority Data
Oct. 7, 2014 (FR) 14 59600

(51) Int. Cl. B25J 9/16

(52) U.S. Cl. CPC B25J 9/1633; B25J 9/1641; G05B 2219/39186; G05B 2219/39201; G05B 2219/39338; G05B 2219/42012

(57) ABSTRACT

The invention relates to a method of control ling an actuator (1) of an articulated segment (5) comprising the steps of estimating an inertia J of the segment; estimating or measuring a speed of displacement (I) of the segment; synthesizing a control law of type (II) generating a control torque for the segment on the basis of these estimates or measurements and meeting a performance objective pertaining to the loading sensitivity function: (III) K being the desired stiffness, and c a desired damping rate, a a mathematical artifact, (IV), where G(s) is the transfer function (V) for going between the speed (I) (linear or angular) of the segment and an external force F experienced by the segment; and controlling the actuator of the articulated segment according to the control law thus synthesized.

$$\begin{matrix}\dot{X} & ( I ) \\ {H}_{∞} & ( II ) \\ {‖ {S}_{F} ( s ) {W}_{S} ( s ) ‖}_{∞} \leq 1 avec {W}_{s} ( s ) = {( \frac{{J}_{s}^{2} + ɛ}{{J}_{s}^{2} + cs + K} )}^{- 1} & ( III ) \\ {S}_{F} ( s ) = G ( s ) \cdot J \cdot s & ( IV ) \\ G ( s ) = \dot{X} / F & ( V )\end{matrix}$$

The invention relates to a method of controlling a robotized arm segment making it possible to adapt the apparent stiffness thereof.

### TECHNOLOGICAL BACKGROUND OF THE INVENTION

Robotic manipulation has evolved from the manipula tion in free space (welding, lifting and positioning uses, etc.) to carrying out contact tasks (brushing, inserting, remote manipulation with force feedback).

Thus, rather than a pure positional feedback control, which requires a precise knowledge of the destination position and of the path, the requirement has evolved towards a more flexible feedback control allowing the manipulator arm to compromise with an imperfect knowledge of the destination position.

The conventional example is the task of inserting a piece into an opening by means of a manipulator arm. With positional feedback control, it would be necessary to have a precise knowledge of the position of the opening with the aim of inserting the piece into the opening.

In order to overcome this disadvantage, it is known to use impedance or stiffness feedback control, giving the manipulator arm a behavior of great stiffness in the direction of inserting the piece, and a behavior of low stiffness in the transverse directions, allowing the manipulator arm to carry out the insertion task despite an imprecise knowledge of the position of the opening.

This type of control is relatively easy to use if the robot is considered to be structurally rigid and the controller uses a proportional derivative position, proportional integral speed, or proportional integral deriv ative effort corrector. Indeed, exact mathematical expressions exist between the desired stiffness, the parameters of the model of the robot, and those of the controller, whether it provides, or not, the passivity of the robot, which allows the use of an analytic calculation. As soon as the rigidity hypothesis of the robot is no longer acceptable, or the intention would be to use other types of controllers, such an analytical calculation is no longer possible.

### OBJECT OF THE INVENTION

The object of the invention is to propose a control method making it possible to adapt the stiffness of the manipulator arm to the required task, without it having to be considered as rigid, and being able to adapt to varied control forms, not necessarily reduced to PID.

### PRESENTATION OF THE INVENTION

Modifying the apparent stiffness amounts to modifying the form of the transfer function G(s)=\dot{X}/F between a speed \dot{X} (linear or angular) of the segment and an external force F to which the segment is subjected such that it is the closest possible to an ideal transfer function of an object of mass (or of inertia) M linked to a frame by a spring of stiffness K (linear or angular), possibly subjected to a damping of rate c. It is known that such an ideal transfer function has the form

$$\frac{s}{{Ms}^{2} + cs + K}$$

where s is the Laplace variable. Hereafter, S_{F}(s) is noted as the segment+controller system sensitivity function assessed at the effort experienced:

S_{F}(s)=G(s)·J·s

where J is the mass (or the inertia) of the segment to be controlled, with the exclusion of the inertia of the motor to be controlled and of any other intermediate element, if they can be separated. It is recalled that the sensitivity function measures the sensitivity of a feedback control loop with an interference which is added to a given signal.

To achieve this aim, the invention proposes a method of controlling an actuator of a hinged segment including the steps of:
estimating an inertia J of the segment;
estimating or measuring a movement speed \dot{X} of the segment;
synthesizing a control law of type H_{∞} generating a control torque for the segment on the basis of these estimates or measurements and meeting a performance objective having the effort sensitivity function:

$$\vert \vert {S}_{F} ( s ) {W}_{s} ( s ) {\vert \vert}_{∞} \leq 1 where {W}_{s} ( s ) = {( \frac{{Js}^{2} + s}{Js + cs + K} )}^{- 1}$$

K being a desired stiffness, and c a desired damping, being a mathematical artifact;
controlling the actuator of the hinged segment according to the control law thus synthesized.

According to a specific aspect of the invention, the control synthesis is carried out under at least one of the following constraints:
a constraint relating to the assessed position or speed sensitivity of the segment+controller system, namely: ∥S_{X}(s)W_{z}(s)∥_{∞}≦1 or ∥S_{\dot{X}}(s)W_{Z}(s)∥_{∞}≦1
a constraint relating to the supply current (or control torque) for the motor which must not exceed a given threshold for all of the admissible efforts;
a constraint relating to the positions of the poles of the control law, which poles must all be located below a threshold frequency less than the Nyquist frequency;
a constraint relating to the positions of the poles of the control law which must have a minimum damping ζ.
a passivity constraint according to which the Force/Speed transfer function must be positive-real.

### BRIEF DESCRIPTION OF THE DRAWINGS

The invention will be better understood in light of the following description of a nonlimiting specific method of implementing the invention, with reference to the figures of the appended drawings wherein:

FIG. 1 is a schematic view of a comanipulator arm segment actuated by means of a cable actuator;

FIG. 2 is a graph showing the Bode plot of the segment and the threshold function;

FIG. 3 is a block diagram of the feedback control implemented by means of the invention.

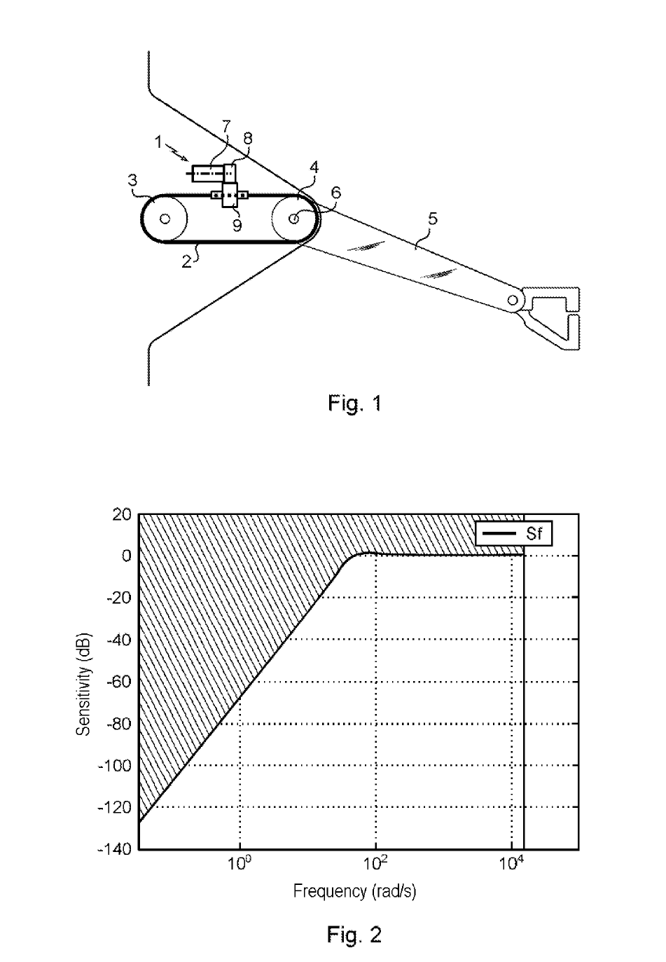

### DETAILED DESCRIPTION OF A METHOD OF IMPLEMENTING THE INVENTION

Referring to the figures, the invention is, in this case, used to control a hinged segment of a robot arm that can be used with comanipulation. The robot includes an actuator 1 moving a cable 2 wound about a return pulley 3 and about a hinge pulley 4 leading a segment 5 that is hinged about a hinge pin 6. In this case, the actuator includes a motor 7 associated with a reduction gear 8 which drives the nut of a ball transmission 9, the socket screw of which is connected to the cable 2 which passes inside the screw.

According to the invention, the first step is to estimate the inertia J of the hinged segment 5 about the hinge pin 6. Various methods are known for estimating such an inertia. For example, it is possible, from the definition of the segment, to add the specific inertias of all of the elements making up the segment to an inertia about the hinge pin 6 and total all of these inertias.

The method of the invention includes the step of synthesizing a control law for the actuator 1 such that the hinged segment 5 behaves as if the segment had a chosen stiffness K and was subjected to a damping c. This damping can be deduced from a damping rate ζ f by c=2Σ\sqrt{KJ}.

For this purpose, the transfer function G(s)=\dot{X}/F is measured, where \dot{X} is the speed of the hinged segment 5, and F is the external effort acting on the hinged segment 5 (for example, the weight of a load that the segment lifts). The variable s is the Laplace variable.

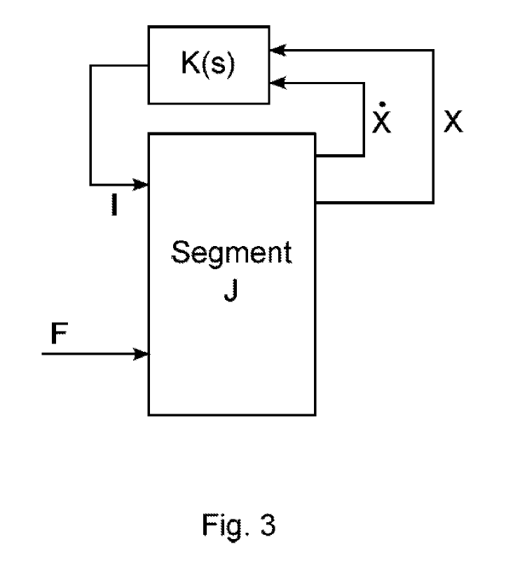

Using the conventional tools for the synthesis H_{∞}, a control law is determined, the inputs of which are the speed \dot{X} and the output is a control torque, represented in this case by a control current (or torque) I, as is shown in the diagram of FIG. 3. The synthesis meets the following objective: ∥Sₚ(s)Wₛ(s)∥_{∞}≦1, wherein the threshold is

$${W}_{s} ( s ) = {( \frac{{Js}^{2} + s}{{Js}^{2} + cs + K} )}^{- 1} ,$$

K being the desired stiffness, and c the desired damping, ε being a mathematical artefact intended to prevent infinite gains at low frequency. To this end, S_{F}(s) is the segment+controller system sensitivity function assessed at the effort experienced: S_{F}(s)=G(s)·J·s, where J is the mass (or the inertia) of the segment. G(s) is the transfer function G(s)=\dot{X}/F between the speed _k (linear or angular) of the segment and an external force F to which the segment is subjected.

Namely, it is required that the characteristic curve in a Bode plot of the transfer function S_{F}(s) is below the characteristic curve of the threshold function Wₛ(s).

Then, once the control law has been synthesized as has just been stated, this control law is used to control the actuator.

Moreover, and according to a specific aspect of the invention, at least one of the following constraints is required:
a constraint with the supply current (or control torque) for the motor which must not exceed a given threshold for all of the admissible efforts. This constraint is met by the requirement that |J/F|_{∞}≦S, where I is the strength of the current powering the motor of the actuator (or the torque required of the motor), and S is a determined threshold;
a constraint relating to the positions of the poles of the control law, which poles must all be located below a threshold frequency Fₛ less than or equal to the Nyquist frequency;
a passivity constraint according to which the Speed/Force transfer transfer function

$$H = \frac{\dot{x}}{F}$$

must be positive-real. It is recalled that a transfer function H is positive-real if

$$\vert \frac{1 - H}{1 + H} {\vert}_{∞} < 1 ;$$

a constraint relating to the segment+controller system sensitivity assessed at the position reference according to which: ∥S_{X}(s)Wₛ(s)∥_{∞}≦1, where

$${S}_{x} = 1 - \frac{x}{{x}_{ref}} ,$$

with X being the position of the robot and X_{ref} being the position reference;
a constraint relating to the segment+controller system sensitivity assessed at the speed reference according to which: ∥S_{X}(s)Wₛ(s)∥_{∞}≦1 where

$${S}_{\dot{x}} = 1 - \frac{\dot{x}}{{\dot{x}}_{ref}} ,$$

with \dot{X} being the speed of the robot and \dot{X}_{ref} being the speed reference;
a constraint relating to the damping of the poles of the closed loop system according to which these poles must comply with the following inequation:

$$\frac{\vert Re ( p ) \vert}{\vert p \vert} \geq ξ ,$$

where Re denotes the real part of the poles. The effect of this constraint is to reinforce the damping requirement expressed in the weighting function Wₛ.

In the examples described below, the stiffness K is fixed at a determined value. However, it can be useful to vary the stiffness over time. For this purpose, and according to an alternative of the invention, this stiffness K is explicitly included as a variable exogenous parameter both in the sensitivity function and in the threshold function for the purpose of performance: ∥S_{P}(K,s)Wₛ(K,s)∥_{∞}≦1.

In this formulation of the problem to be solved, K is now considered as a variable. In order to solve this problem for all Kₘᵢₙ≦K≦Kₘₐₓ, it is sufficient to simultaneously solve the problems:

∥S_{F}(Kₘᵢₙ,s)Wₛ(Kₘₐₓ,s)∥_{∞}≦1 et ∥S_{F}(Kₘᵢₙ,s)Wₛ(Kₘₐₓ,s)∥_{∞}≦1.

The invention is not limited to the above description, but includes, on the contrary, any alternative falling within the scope defined by the claims. In par ticular, the inertial characteristics (position, speed, acceleration) of the arm segment can relate to both linear movements and angular movements.

1. A method of controlling an actuator (1) of a hinged segment (5) including the steps of:
estimating an inertia J of the segment;
estimating or measuring a movement speed \dot{X} of the segment;
synthesizing a control law of type H_{∞} generating a control torque for the segment on the basis of these estimates or measurements and meeting a performance objective having the effort sensitivity function:
$$\vert \vert {S}_{F} ( s ) {W}_{s} ( s ) {\vert \vert}_{∞} \leq 1 where {W}_{s} ( s ) = {( \frac{{Js}^{2} + s}{Js + cs + K} )}^{- 1}$$
K being a desired stiffness, and c a desired damping, a mathematical artifact, S_{F}(s)=G(s)·J·s, where G(s) is the transfer function G(s)=\dot{X}/F between the speed X (linear or angular) of the segment and an external force F to which the segment is subjected;
controlling the actuator of the hinged segment according to the control law thus synthesized.

2. The method as claimed in claim 1, wherein the control synthesis is carried out under at least one of the following constraints:
a constraint with the supply current (or control torque) for the motor which must not exceed a given threshold for all of the admissible efforts. This constraint is met by the requirement that |J/F|_{∞}23 S, where I is the strength of the current powering the motor of the actuator (or the torque required of the motor), and S is a determined threshold;
a constraint relating to the positions of the poles of the control law, which poles must all be located below a threshold frequency Fₛ less than or equal to the Nyquist frequency;
a passivity constraint according to which the Speed/Force transfer transfer function
$$H = \frac{\dot{x}}{F}$$
must be positive-real. It is recalled that a transfer function H is positive-real if
$$\vert \frac{1 - H}{1 + H} {\vert}_{∞} < 1 ;$$
a constraint relating to the segment+controller system sensitivity assessed at the position reference according to which: ∥S_{X}(s)Wₛ(s)∥_{∞}≦1;
a constraint relating to the segment+controller system sensitivity assessed at the speed reference according to which: ∥S_{X}(s)Wₛ(s)∥_{∞}≦1;
a constraint relating to the damping of the poles of the closed loop system according to which these poles must comply with the following inequation:
$$\frac{\vert Re ( p ) \vert}{\vert p \vert} \geq ξ ,$$
where Re denotes the real part of the poles.

3. The method as claimed in claim 1, wherein, in the synthesis of the control law, the stiffness K is explicitly included as a variable exogenous parameter both in the sensitivity function and in the threshold function for the purpose of performance:
∥S_{F}(K,s)Wₛ(K,s)∥_{∞}≦1.

4. The method as claimed in claim 3, wherein, to solve the problem for all Kₘᵢₙ≦K≦Kₘₐₓ, the following problems are solved simultaneously:
∥S_{F}(Kₘᵢₙ,s)Wₛ(Kₘₐₓ,s)∥_{∞}≦1 et ∥S_{F}(Kₘᵢₙ,s)Wₛ(Kₘₐₓ,s)∥_{∞}≦1.
